(19) United States
(12) Patent Application Publication
(10) Pub. No.: US 2006/0169413 A1
(43) Pub. Date: Aug. 3, 2006

(54) Corrugating belt for supporting/conveying corrugated cardboard in a corrugating machine

(75) Inventor: Paolo Franchi, Brescia (IT)

Correspondence Address: MARGER JOHNSON & MCCOLLOM, P.C., 210 SW MORRISON STREET, SUITE 400, PORTLAND, OR, 97204, US

(73) Assignee: Feltri Marone S.p.A., Marone (IT)

(21) Appl. No.: 11/341,862

(22) Filed: Jan. 26, 2006

(30) Foreign Application Priority Data
Jan. 28, 2005 (IT) MI2005A 000123

(51) Int. Cl. B31F 1/20

(52) U.S. Cl. 156/462; 156/470

(57) ABSTRACT

It is provided a corrugating belt for supporting/conveying corrugated cardboard in a corrugating machine, having a gas-permeable belt substrate and provided with a working surface facing in use the cardboard to be conveyed; the working surface presents feeding zones, which have a polymeric material coating increasing the friction coefficient between the working surface and the cardboard, alternated with transpiration zones, in which the working surface is not coated with polymeric material and the corrugating belt is gas-permeable.

### RELATED APPLICATION DATA

This application claims priority from Italian patent application no. MI2005A 000123 filed Jan. 28, 2005, incorporated herein by reference.

### BACKGROUND OF THE INVENTION

The present invention relates to the corrugated cardboard manufacturing sector and refers, more precisely, to the so-called corrugating belts which are used to support and/or convey the corrugated cardboard in the corrugated cardboard manufacturing machines.

It is known that particular corrugating machines are used for manufacturing corrugated cardboards, of the type usually used for manufacturing boxes or various packaging; typically, after the various layers of the corrugated cardboard have been glued to each other, the cardboard is sent through a heated plate heating zone and then through a cooling zone.

The cardboard is fed into the corrugating machine by looped corrugating belts; the fed of the cardboard in the corrugating machine is essentially ensured by the friction between the outer surface of the closed loop corrugating belt (on cardboard side) and the cardboard itself.

There are various versions of corrugating machines having, in particular, different modes of feeding the cardboard through the heating zones.

For example, in a first type of corrugating machines, the corrugating belt on which the cardboard rests is pressed against the heating plates by pressing rollers which exert a pressure sufficient to ensure, in addition to the contact with the heated plates, also the feeding of the cardboard.

In a second type of machine, the corrugating belt which feeds the cardboard in the heating zone is pressed against the heated plates by air cushions instead of pressing rollers.

In a third type of machines, no corrugating belt is used in the heating zone, and the cardboard is fed through the heating zone by a pair of belts arranged in the cooling zone (downstream of the heating zone) and holding the cardboard from opposite sides.

Especially this type of machine, however in general all corrugating machines, requires a high friction coefficient between the corrugating belts and the cardboard.

A high friction coefficient corrugating belt is known from EP-A-0950508, which illustrates a corrugating belt whose outer surface (on cardboard side) is uniformly coated with a layer of polymeric material. The corrugating belt here mentioned and other similar solutions however present the main drawback of being substantially impermeable, due exactly to their polymeric coating and therefore, in addition to slowing down the dispersion of steam let out from the cardboard, make necessary the application on the cardboard of a relatively high amount of glue.

Furthermore, such corrugating belts are relatively heavy and costly, being completely coated with polymeric material.

### SUMMARY OF THE INVENTION

It is an object of the present invention to overcome the highlighted drawbacks of the known art.

The present invention therefore relates to a corrugating belt for supporting/conveying corrugated cardboard in a corrugating machine, comprising a gas-permeable belt substrate and having a working surface facing in use the cardboard to be conveyed; the corrugating belt being characterised in that said working surface presents feeding zones, which have a polymeric material coating adapted to increase the friction coefficient between the working surface and the cardboard, alternated with transpiration zones, in which the working surface is not coated with polymeric material and the corrugating belt is gas-permeable.

In this way, the corrugating belt of the invention ensures an appropriate friction with the cardboard, being therefore fully efficient for feeding the cardboard in any type of machine where it is installed; at the same time, the corrugating belt of the invention has a high permeability and therefore a high evaporation capacity, which allows a rapid and effective dispersion of steam let out from the cardboard during machining and allows also the use of small amounts of glue.

The corrugating belt of the invention is therefore extremely versatile, as it can be used in all types of corrugating machines, including those requiring a high friction coefficient with the cardboard and those in which it is necessary to ensure the permeability of the corrugating belt.

Finally, the corrugating belt of the invention is relatively light in weight and inexpensive.

The foregoing and other objects, features and advantages will become more readily apparent from the following detailed description of embodiments of the invention which proceeds with reference to the accompanying drawings.

### BRIEF DESCRIPTION OF THE DRAWINGS

Further features and advantages of the present invention will be apparent in the following description of some non-limitative example of embodiments thereof, with reference to the accompanying drawings, in which:

FIGS. 1 and 2 schematically show the general structure, however known, of two versions of corrugating machines for manufacturing corrugated cardboard, equipped with corrugating belts according to the invention;

FIG. 3 is a schematic view not in scale of a portion of a corrugating belt according to a first embodiment of the invention;

FIGS. from 4 to 6 show respective alternative embodiments of the corrugating belt according to the invention.

### DETAILED DESCRIPTION

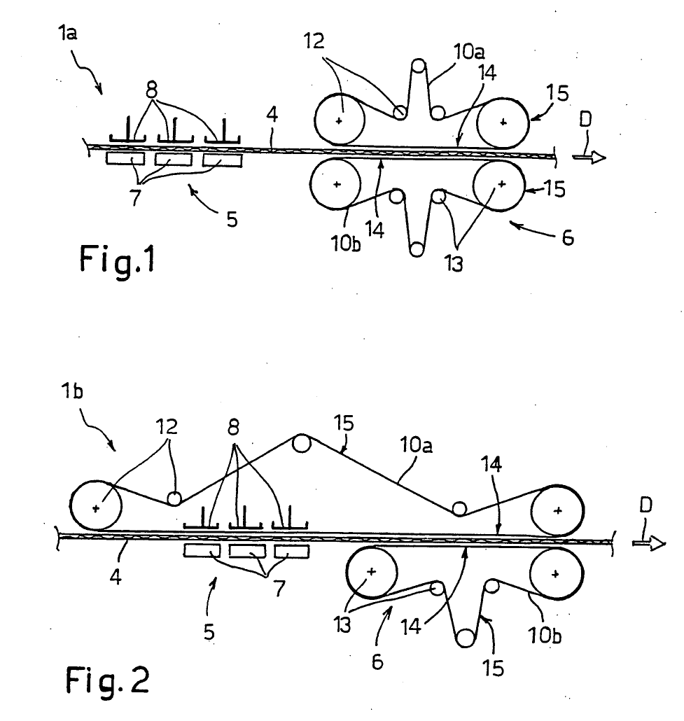

FIG. 1 schematically shows a corrugating machine la for manufacturing corrugated cardboard having an essentially known general structure and operation.

Generally, machine 1a comprises an upper corrugating belt 10a and a lower corrugating belt lob which feed a corrugated cardboard web 4 along a feeding direction D through a heating zone 5 and a cooling zone 6, arranged downstream of heating zone 5 along feeding direction D.

Cardboard 4, as known, is formed by layers of paper material glued to each other. Heating zone 5 comprises a series of heated plates 7 for drying and/or reticulating the glue used for gluing the various layers of cardboard 4, and a series of presses 8 (or other equivalent pressing members, for example rollers or air cushions) associated to plates 7 for pressing cardboard 4 against plates 7.

After having crossed heating zone 5, cardboard 4 is fed by corrugating belts 10a, 10b into cooling zone 6, where corrugating belts 10a, 10b make contact with respective opposite sides of cardboard 4 and cardboard 4 is sandwiched between corrugating belts 10a, 10b. Corrugating belts 10a, 10b make contact with cardboard 4 along respective segments substantially of the same length.

Corrugating belts 10a, 10b are closed in a loop and wound on respective groups of cylinders 12, 13 which maintain corrugating belts 10a, 10b taut. Each of corrugating belts 10a, 10b presents, when closed in a loop and installed on machine 1a, an inner face 14 cooperating with cylinders 12 or 13 and an outer face 15 which makes contact with cardboard 4.

FIG. 2, in which details similar or equal to those already described are indicated with the same numbers, shows a machine 1b (again essentially known) in which, with respect to machine la in FIG. 1 (where corrugating belts 10a, 10b make contact with cardboard 4 along respective segments of substantially equal length), one of the corrugating belts, for example the upper corrugating belt 10a, makes contact with cardboard 4 for a significantly longer segment with respect to the other corrugating belt, the lower corrugating belt 10b in the example.

For the rest, machine 1b is substantially similar to machine 1a already described.

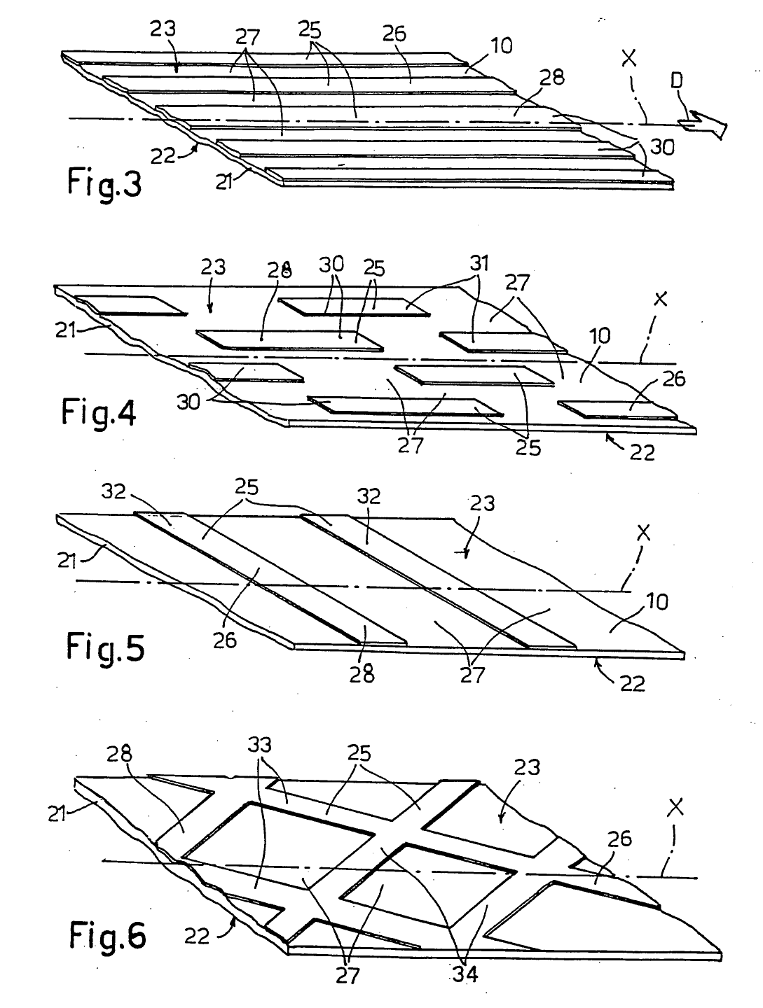

FIG. 3 shows a corrugating belt 10 which may be used as upper corrugating belt 10a and/or as lower corrugating belt 10b in machines 1a, 1b (and, clearly, in any other corrugating machine for manufacturing corrugated cardboard).

Corrugating belt 10 is extended along a longitudinal axis X and comprises a gas-permeable substrate 21 delimited by a service surface 22 and by a working surface 23, opposite to one another and defining in use (that is when corrugating belt 10 is closed in a loop and installed in a corrugating machine) inner face 14 and, respectively, outer face 15 of corrugating belt 10.

Substrate 21 is a substrate of a known type, for example a fabric or felt substrate, a non-woven fabric substrate, or a multispiral mat.

Working surface 23, facing in use cardboard 4, presents feeding zones 25, which have a polymeric material coating 26 adapted to increase the friction coefficient between working surface 23 and cardboard 4, alternated with transpiration zones 27, in which working surface 23 is not coated with polymeric material and corrugating belt 10 is gas-permeable.

Working surface 23 is provided with a coating layer 28 of polymeric material spread on working surface 23 and extending only partially to cover working surface 23; coating layer 28 is arranged only on feeding zones 26, and leaves uncoated zones of working surface 23 that define transpiration zones 27.

The polymeric material with which coating layer 28 is made is any polymeric material suitable for increasing the friction coefficient of working surface 23 with cardboard 4, for example a polyurethane based polymeric material, a silicon material or any other high friction coefficient material.

Service surface 22 is not coated with polymeric material and is therefore gas-permeable.

Feeding zones 25 may be variably arranged and differently extended on working surface 23, having different dimensions and shapes.

Generally, feeding zones 25 extend to cover at least 10% of working surface 23 and preferably cover from about 15 to about 80% of working surface 23; more preferably, feeding zones 25 cover from about 30 to about 50% of working surface 23.

In the example in FIG. 3, feeding zones 25 comprise a plurality of strips 30, substantially longitudinal and substantially parallel to each other; strips 30 may be parallel to the axis X and therefore parallel, in use, to feeding direction D of cardboard 4 (as shown in FIG. 3), or be slanted or oblique with respect to axis X.

Strips 30 may have all the same width or have different widths; for example, in FIG. 3 there are shown strips having gradually decreasing width from the centre of corrugating belt 10 towards the side edges of corrugating belt 10.

Strips 30 may be longitudinally continuous strips, as indeed shown in FIG. 3, or, as shown for example in FIG. 4, be discontinuous strips, that is formed by separate consecutive segments 31, aligned or laterally offset respect to each other.

In the variation of FIG. 5, feeding zones 25 comprise a plurality of strips 32 arranged substantially traversally to axis X and, therefore, to feeding direction D. In the example in FIG. 5, strips 32 are substantially orthogonal to axis X and reciprocally parallel, but is understood that strips 32 may also be variably slanted with respect to each other.

In the variation of FIG. 6, feeding zones 25 comprise strips 33, 34 oblique with respect to the axis X; in particular, in the example in FIG. 6 two series of reciprocally parallel and crossed strips 33, 34 are envisaged. Strips 33, 34 of each series may be variably and reciprocally slanted instead of being substantially parallel to each other.

It is however clear that the configurations shown in the annexed drawings are merely examples and that feeding zones 25 may be formed by combinations of the arrangements exemplified here, or by yet other conformations.

It is then understood that further changes and variants may be made to the corrugating belt of the invention without departing from the scope of the annexed claims.

1. A corrugating belt for supporting/conveying corrugated cardboard in a corrugating machine, comprising a gas-permeable belt substrate and having a working surface facing in use the cardboard to be conveyed;
the corrugating belt being characterised in that said working surface presents feeding zones, which have a polymeric material coating adapted to increase the friction coefficient between the working surface and the cardboard, alternated with transpiration zones, in which the working surface is not coated with polymeric material and the corrugating belt is gas-permeable.

2. A corrugating belt according to claim 1, characterised in that said working surface consists of an outer face of the corrugating belt when the corrugating belt is closed in a loop in a corrugating machine.

3. A corrugating belt according to claim 1, characterised in that the substrate is a fabric or felt substrate, or a non-woven fabric substrate, or a multispiral mat.

4. A corrugating belt according to claim 1, characterised in that the polymeric material constitutes a coating layer of the working surface which extends only partially to cover said working surface, leaving uncovered zones of the working surface defining said transpiration zones.

5. A corrugating belt according to claim 1, characterised in that the feeding zones comprise longitudinal strips substantially parallel to a longitudinal axis (X) of the corrugating belt.

6. A corrugating belt according to claim 1, characterised in that the feeding zones comprise longitudinal strips arranged substantially transversally to a longitudinal axis (X) of the corrugating belt.

7. A corrugating belt according to claim 1, characterised in that the feeding zones comprise oblique strips with respect to a longitudinal axis (X) of the corrugating belt.

8. A corrugating belt according to claim 1, characterised in that the feeding zones extend and cover from about 15% to about 80% of the working surface.

9. A corrugating belt according to claim 1, characterised in that the feeding zones cover from about 30% to about 50% of the working surface.

10. A corrugating belt according to claim 1, characterised in that the feeding zones extend and cover at least 10% of the working surface.
